(19) United States
(12) Patent Application Publication
(10) Pub. No.: US 2026/0287382 A1
(43) Pub. Date: Sep. 24, 2026

(54) IN-VEHICLE SYSTEM AND STORAGE MEDIUM

(71) Applicant: SONY HONDA MOBILITY INC., Tokyo (JP)

(72) Inventors: Ryu TATE, Tokyo (JP); Hiroki TSUTSUMI, Tokyo (JP); Junichi NAGAHARA, Tokyo (JP)

(73) Assignee: SONY HONDA MOBILITY INC., Tokyo (JP)

(21) Appl. No.: 19/088,556

(22) Filed: Mar. 24, 2025

(51) Int. Cl. G01C 21/36

(52) U.S. Cl. CPC G01C 21/3652

(57) ABSTRACT

Navigation more suited to a driving situation is achieved. A navigation information acquisition unit acquires navigation information, the navigation information including information related to a next action of a vehicle and information related to a driving environment of the vehicle, a vibration timing determination unit determines a vibration timing based on the navigation information, the vibration timing being a timing for generating vibration to notify the next action of the vehicle, and a vibration parameter setting unit sets a vibration parameter for controlling the vibration based on the navigation information. The present technology is applicable to, for example, an in-vehicle system of a vehicle with vibration devices mounted on its steering wheel.

### BACKGROUND OF THE INVENTION

### Field of the Invention

The present disclosure relates to an in-vehicle system and a storage medium, and particularly relates to an in-vehicle system and a storage medium with which it is possible to achieve navigation more suited to a driving situation.

### Description of the Related Art

Technologies for conveying information to a driver operating the steering wheel of a vehicle to drive the vehicle by vibrating a vibration device mounted on the steering wheel have been conventionally known.

For example, U.S. Pat. No. 9,623,907 discloses a technology for conveying navigation information to an occupant of a vehicle by driving a plurality of actuators included in a steering mechanism of the vehicle. U.S. Pat. No. 10,286,922 discloses a technology for conveying information indicating a left turn or a right turn to an occupant of a vehicle by vibrating a left-side vibrator or a right-side vibrator disposed on the steering wheel of the vehicle.

It is thought to be possible to achieve navigation more suited to the driving situation than in conventional cases by controlling the timing for vibrating the steering wheel, the intensity, the frequency, and the pattern of the vibration, and the like based on, for example, a travel location or a speed limit where the vehicle is traveling, or the next action of the vehicle.

The present disclosure is made in view of such a situation and makes it possible to achieve navigation more suited to a driving situation.

### SUMMARY OF THE INVENTION

An in-vehicle system according to an aspect of the present disclosure includes: a navigation information acquisition unit configured to acquire navigation information, the navigation information including information related to a next action of a vehicle and information related to a driving environment of the vehicle; a vibration timing determination unit configured to determine, based on the navigation information, a vibration timing that is a timing for generating vibration to notify the next action of the vehicle; and a vibration parameter setting unit configured to set, based on the navigation information, a vibration parameter for controlling the vibration.

A storage medium according to an aspect of the present disclosure stores a program for causing a computer to execute processing including: acquiring navigation information, the navigation information including information related to a next action of a vehicle and information related to a driving environment of the vehicle; determining a vibration timing based on the navigation information, the vibration timing being a timing for generating vibration to notify the next action of the vehicle; and setting a vibration parameter for controlling the vibration based on the navigation information.

In an aspect of the present disclosure, navigation information is acquired, the navigation information including information related to a next action of a vehicle and information related to a driving environment of the vehicle, a vibration timing that is a timing for generating vibration to notify the next action of the vehicle is determined based on the navigation information, and a vibration parameter for controlling the vibration is set based on the navigation information.

According to an aspect of the present disclosure, it is possible to achieve navigation more suited to a driving situation.

Note that effects described herein are not necessarily limiting, and any effect described in the present disclosure may be applicable.

### BRIEF DESCRIPTION OF THE DRAWINGS

FIG. 1 is a diagram schematically illustrating the interior of a cabin of a vehicle in which a steering wheel Sw with vibration devices VD1 and VD2 mounted thereon is installed;

FIG. 2 is a diagram illustrating an exemplary configuration of a system including a control device 100;

FIG. 3 is a block diagram illustrating an exemplary functional configuration of a vibration control system 200;

FIG. 4 is a diagram for description of an example of vibration generated in the steering wheel SW;

FIG. 5 is a flowchart for description of vibration control processing; and

FIG. 6 is a flowchart for description of exemplary processing of determining a vibration timing.

### DETAILED DESCRIPTION OF THE INVENTION

The following describes embodiments for implementing the present technology. The description is made in the following order.
1. Exemplary overall configuration of vehicle
2. Exemplary configuration of vibration control system
3. Exemplary processing of vibration control processing

### Exemplary Overall Configuration of Vehicle

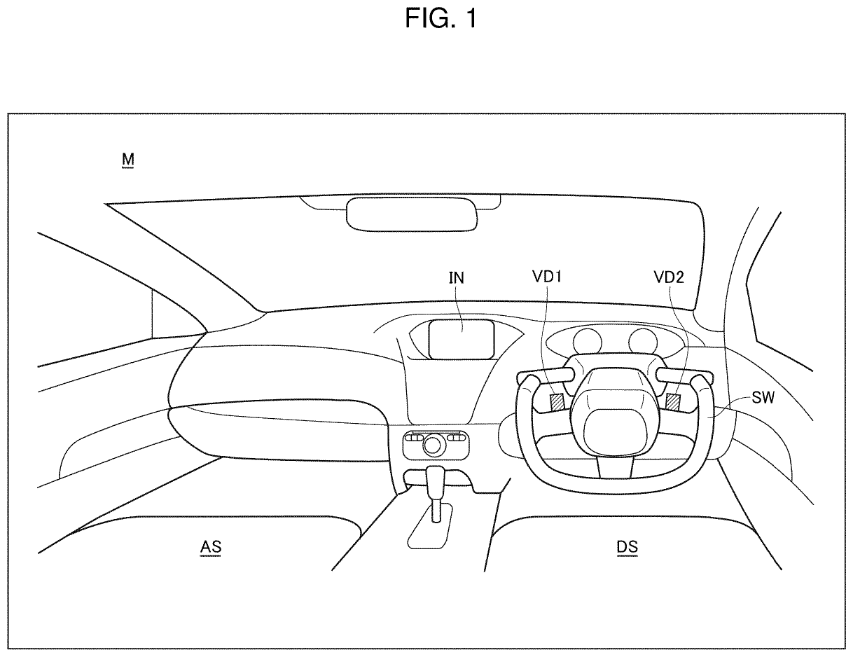

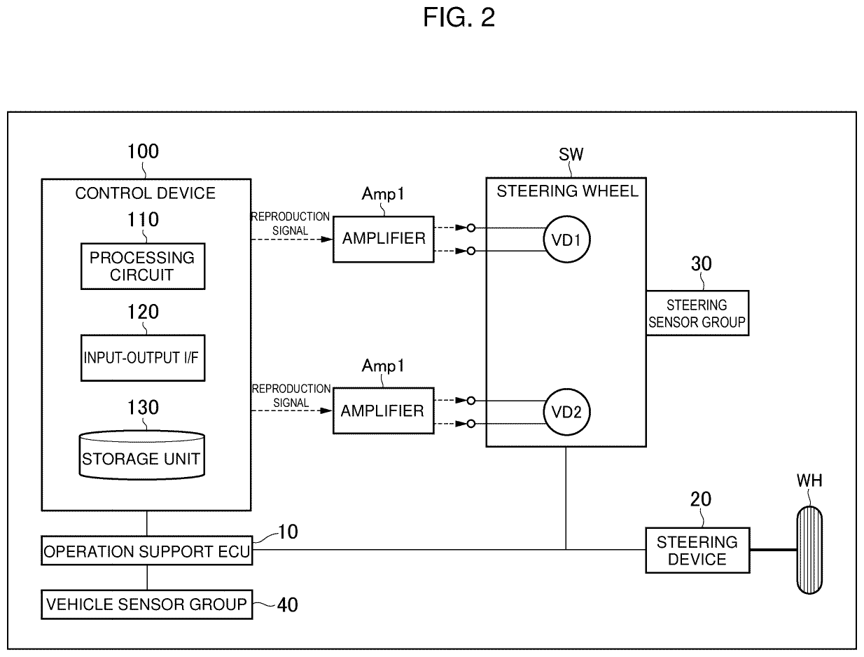

An exemplary overall configuration of a vehicle with a mounted vibration control system to which the present technology is applied will be described below with reference to FIGS. 1 and 2.

FIG. 1 is a diagram schematically illustrating the interior of a cabin of a vehicle M in which a steering wheel SW with vibration devices VD1 and VD2 mounted thereon is installed. FIG. 2 is a diagram illustrating an exemplary configuration of a system including a control device 100 configured to control the vibration devices VD1 and VD2.

The vehicle M includes an instrument panel IN, a driver seat DS, a front passenger seat AS, the steering wheel SW, and the like in the cabin. The vehicle M is, for example, a two-wheeled, three-wheeled, four-wheeled vehicle, and its drive source is an internal combustion engine such as a diesel engine or a gasoline engine, an electric motor, or a combination thereof. FIG. 1 illustrates a case where the vehicle M is a four-wheeled vehicle as an example.

A steering sensor group 30 configured to detect an operation amount (angle) or the presence or absence of an operation is attached to the steering wheel SW, and a detection result is output to an operation support electronic control unit (ECU) 10 and a steering device 20. The steering wheel SW is not necessarily required to be circular and may be a non-circular steering wheel.

In addition, the vibration devices VD1 and VD2 are mounted on the left and right sides of the steering wheel SW. The vibration devices VD1 and VD2 each incorporate a motor, and when receiving a reproduction signal provided by the control device 100 and amplified by amplifiers Amp1 and Amp2, they operate the motors according to the received reproduction signal to generate vibration on the steering wheel SW. The amplifiers Amp1 and Amp2 are connected to the vibration devices VD1 and VD2, respectively, through cable reels.

For example, voice coil motor (VCM) vibrators capable of achieving highly expressive vibration may be used as the vibration devices VD1 and VD2. The VCM vibrators can use, for example, a reproduction signal that reproduces audio when supplied to a speaker as an input, and can achieve haptic directional representation by generating vibrations that realize tonal differentiation such as timbre. Eccentric motors with an unbalanced center of gravity may be used as the vibration devices VD1 and VD2.

As illustrated in FIG. 1, in the present embodiment, the vibration device VD1 is installed on the left side of the steering wheel sw to convey vibration to the left hand of a driver gripping the steering wheel SW, while the vibration device VD2 is installed on the right side of the steering wheel SW to convey vibration to the right hand of the driver gripping the steering wheel SW.

The steering device 20 includes, for example, a steering ECU and an electric motor. For example, the electric motor applies force to a rack-and-pinion mechanism to change a direction of steered wheels WH.

The steering ECU drives the electric motor according to information input from the operation support ECU 10 or information input from the steering wheel SW, thereby changing the direction of the steered wheels WH.

The steering sensor group 30 includes, for example, a steering grip sensor and a vibration displacement sensor. The steering grip sensor is implemented by a capacitive sensor or the like and outputs, to the operation support ECU 10, a signal that enables sensing of whether the driver is gripping the steering wheel SW (that is, in contact with it in a state in which force can be applied). The vibration displacement sensor measures displacement [cm] of vibration generated at each position (point) on the steering wheel SW as vibration intensity and outputs the measured vibration intensity to the control device 100.

In this case, the measured vibration intensity may be directly output to the control device 100 not through the operation support ECU 10.

A vehicle sensor group 40 includes an image sensor installed to capture an image of a surrounding situation of the vehicle M by using a solid image capturing element such as a charge coupled device (CCD) or a complementary metal oxide semiconductor (CMOS), a vehicle speed sensor that detects a speed of the vehicle M, an acceleration sensor that detects its acceleration, a yaw rate sensor that detects its angular velocity about a vertical axis, an orientation sensor that detects an orientation of the vehicle M, and the like.

The operation support ECU 10 executes an advanced driver assistance system (ADAS) based on detection results by the vehicle sensor group 40. The ADAS includes, for example, a lane departure warning (LDW) that warns of departure of the vehicle M from a driving lane. As an example, the operation support ECU 10 can execute the ADAS by generating vibration from the vibration devices VD1 and VD2 through the control device 100.

The control device 100 includes a processing circuit 110, an input-output I/F 120, and a storage unit 130.

The processing circuit 110 is implemented by, for example, a hardware processor such as a central processing unit (CPU) executing a program (software). Some or all of these constituent components may be implemented by hardware (circuit unit; including circuitry) such as a large scale integration (LSI), an application specific integrated circuit (ASIC), a field-programmable gate array (FPGA), a graphics processing unit (GPU), or a system on a chip (SOC), or may be implemented through a collaboration of software and hardware.

The input-output I/F 120 is an interface that mediates input and output of data, signals, and the like between the control device 100 and external systems. For example, a reproduction signal generated by the processing circuit 110 is output to the amplifiers Amp1 and Amp2 through the input-output I/F 120. In addition, navigation information output from a non-illustrated navigation system is input to the processing circuit 110 through the input-output I/F 120. The input-output I/F 120 outputs a display signal for displaying a graphical user interface (GUI) screen on the instrument panel IN and inputs an operation signal according to a GUI operation following a touch on the instrument panel IN.

A storage unit 130 is implemented by a storage device such as a hard disk drive, a flash memory, or a random access memory (RAM) and stores, for example, programs executed by the processing circuit 110 and various kinds of data needed when the processing circuit 110 executes the programs. The programs may be stored in the storage unit 130 in advance or may be stored in a removable storage medium such as a digital versatile disc (DVD) or a compact disc read-only memory (CD-ROM) and installed from a drive device on which the storage medium (non-transitory storage medium) is mounted onto the storage unit 130 through the input-output I/F 120.

### Exemplary Configuration of Vibration Control System

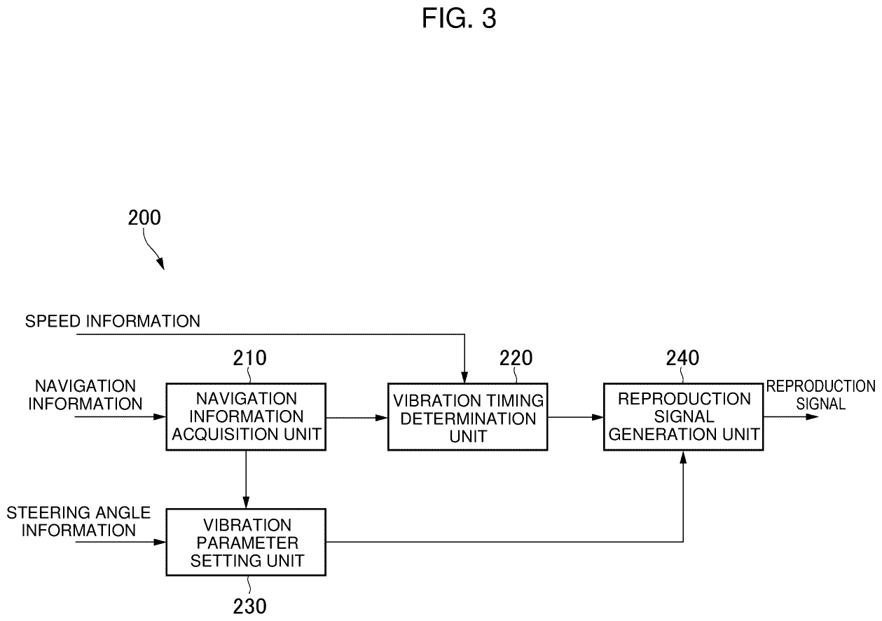

FIG. 3 is a block diagram illustrating an exemplary functional configuration of a vibration control system 200 implemented by the control device 100 in FIG. 2 executing a vibration control program.

As illustrated in FIG. 3, the vibration control system 200 includes a navigation information acquisition unit 210, a vibration timing determination unit 220, a vibration parameter setting unit 230, and a reproduction signal generation unit 240.

The navigation information acquisition unit 210 acquires navigation information input from the non-illustrated navigation system to the processing circuit 110 through the input-output I/F 120 (FIG. 2). For example, next-action information and driving environment information are included in the navigation information.

The navigation information acquisition unit 210 supplies the next-action information and the driving environment information to the vibration timing determination unit 220 and supplies the next-action information to the vibration parameter setting unit 230.

For example, the next-action information is information related to the next action to be executed by the vehicle M and includes information indicating the content of the next action (for example, a right turn, a left turn, straight traveling, and a lane change), and information indicating a distance to a location where the next action is to be performed. The driving environment information is information related to a surrounding environment where the vehicle M is traveling, and includes information indicating a travel location (for example, a highway, an urban area, or a suburban area) and information indicating a speed limit (for example, at or below a first speed limit, within a range that is at or below the first speed limit and at or above a second speed limit, or at or below the second speed limit).

Based on the next-action information and the driving environment information supplied from the navigation information acquisition unit 210 and speed information indicating the speed of the vehicle M detected by the vehicle speed sensor of the vehicle sensor group 40, the vibration timing determination unit 220 determines a timing (hereinafter referred to as a vibration timing) for notifying the driver of the next action by generating vibration in the steering wheel SW. Then, the vibration timing determination unit 220 supplies vibration timing information indicating the vibration timing to the reproduction signal generation unit 240.

For example, a specified time (such as 20 seconds or 40 seconds; a predetermined time that does not depend on the travel location and the speed limit) is set to the vibration timing determination unit 220, the specified time being a time between an estimated timing at which the vehicle reaches the location where the next action is to be performed and a predetermined timing earlier than the timing and being a time indicating a timing for starting vibration of the steering wheel SW. In addition, a set distance (such as 20 m or 40 m; a distance that is set in advance according to the travel location and the speed limit) is set to the vibration timing determination unit 220, the set distance being a distance between the location where the next action is to be performed and a predetermined location earlier than the location and being a distance for starting vibration of the steering wheel SW.

The vibration timing determination unit 220 calculates, based on the distance to the location where the next action is to be performed and the speed of the vehicle M indicated by the speed information, an estimated arrival time estimated as a remaining time until the vehicle reaches the location where the next action is to be performed. Then, the vibration timing determination unit 220 can determine, as the vibration timing, the earlier one of the timing at which the estimated arrival time becomes equal to or shorter than the specified time and the timing at which the distance to the location where the next action is to be performed becomes equal to or shorter than the set distance. Moreover, the vibration timing determination unit 220 can change the vibration timing depending on, for example, the distance to the location where the next action is to be performed, the estimated arrival time until the vehicle reaches the location where the next action is to be performed, and the set distance according to the travel location and the speed limit.

To control vibration generated in the steering wheel SW, the vibration parameter setting unit 230 sets a vibration parameter indicating the intensity, the frequency, the pattern, or the like of the vibration based on the next-action information supplied from the navigation information acquisition unit 210 and steering angle information indicating the angle of the steering wheel SW detected by the steering sensor group 30. Then, the vibration parameter setting unit 230 supplies vibration parameter information indicating a parameter for vibration to be generated in the steering wheel Sw to the reproduction signal generation unit 240.

For example, by referring to the next-action information, the vibration parameter setting unit 230 can change the vibration parameter based on the content of the next action (for example, a right turn, a left turn, straight traveling, or a lane change) or the distance to the location where the next action is to be performed. Specifically, the vibration parameter setting unit 230 sets the vibration parameter for vibration according to the content of the next action and changes the intensity, the frequency, and the pattern of the vibration so that the vibration is more clearly conveyed as the vehicle approaches the location where the next action is to be performed.

For example, the vibration parameter setting unit 230 sets the vibration parameter so that vibration for notifying the next action to be performed is performed at a timing at a long distance from the location where the next action is to be performed. When a lane change for performing the next action is required, the vibration parameter setting unit 230 sets the vibration parameter so that vibration for notifying a lane change to be required is performed at a timing at a medium distance from the location where the next action is to be performed. Then, the vibration parameter setting unit 230 sets the vibration parameter for notifying execution of the next action at a timing at a short distance when the vehicle reaches a location immediately before the location where the next action is to be performed. In addition, the vibration parameter setting unit 230 may set the vibration parameter so that vibration for notifying the next action is performed when an action is completed.

The vibration parameter setting unit 230 can recognize the angle of the steering wheel SW according to an operation by the driver based on the steering angle information and can set the vibration parameter (such as the phase or intensity of vibration) so that the vibration source is located at a fixed position (for example, in a case of a right turn, the vibration source is located at a fixed position on the right side of the steering wheel SW even when the steering wheel SW is rotating rightward). For example, the vibration parameter setting unit 230 can adjust the intensity, the phase, or the like of vibration according to the direction of a right or left turn by setting the vibration parameter adapted to the disposition position of each of the plurality of vibration devices VD.

The reproduction signal generation unit 240 generates a reproduction signal for generating vibration in the steering wheel SW according to the vibration parameter indicated by the vibration parameter information supplied from the vibration parameter setting unit 230 at the vibration timing indicated by the vibration timing information supplied from the vibration timing determination unit 220. Then, the reproduction signal generation unit 240 outputs the reproduction signal to the amplifiers Amp1 and Amp2 through the input-output I/F 120 (FIG. 2).

Accordingly, the vibration device VD1 vibrates according to the reproduction signal amplified by the amplifier Amp1 and the vibration device VD2 vibrates according to the reproduction signal amplified by the amplifier Amp2, thereby generating desired vibration in the steering wheel SW.

The vibration control system 200 configured as described above can control vibration generated in the steering wheel SW in coordination with the navigation system, thereby achieving navigation suited to the driving situation of the vehicle M.

For example, the vibration control system 200 can determine the vibration timing based on the travel location and the speed limit where the vehicle M is traveling and the like and set the vibration parameter based on the content of the next action and the distance to the location where the next action is to be performed. Thus, the vibration control system 200 can provide more intuitive navigation by controlling vibration generated in the steering wheel SW.

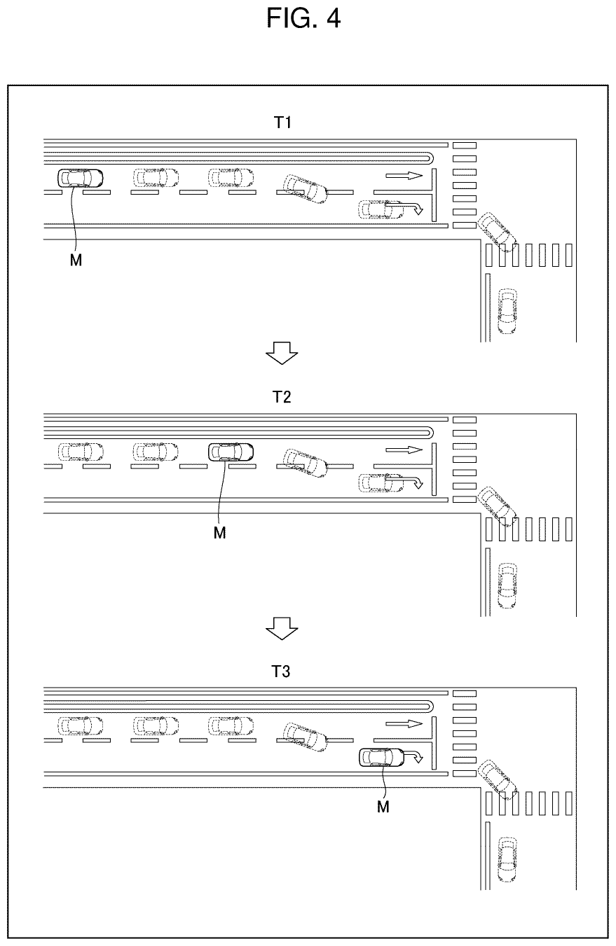

An example of vibration generated in the steering wheel SW by the vibration control system 200 executing vibration control processing (in the illustrated example, vibration when the vehicle M makes a right turn) will be described below with reference to FIG. 4.

A position of the vehicle M at time point T1 is illustrated with solid lines at the upper part of FIG. 4, a position of the vehicle M at time point T2 is illustrated with solid lines at the middle part of FIG. 4, and a position of the vehicle M at time point T3 is illustrated with solid lines at the lower part of FIG. 4. Positions of the vehicle M at time points other than these time points are illustrated with dashed lines.

First, when having detected that the next action is a right turn according to the navigation information acquired by the navigation information acquisition unit 210, the vibration timing determination unit 220 calculates, based on the distance to a location where the right turn is to be performed and the speed of the vehicle M, an estimated arrival time at which the vehicle reaches the location where the right turn is to be performed. In addition, the vibration parameter setting unit 230 sets a vibration parameter for notifying that the next action is the right turn. Then, the vibration timing determination unit 220 determines the set distance for notifying that the next action is the right turn according to the travel location, the speed limit, and the like to determine a vibration timing.

Then, at time point T1, which is the vibration timing for notifying that the next action is the right turn, the reproduction signal generation unit 240 generates a reproduction signal for generating vibration in the steering wheel SW according to the vibration parameter for notifying that the next action is the right turn and supplies the reproduction signal to the vibration devices VD1 and VD2. With this configuration, it is possible to generate vibration in the steering wheel SW to notify that the next action is the right turn, thereby prompting the driver to prepare for making the right turn.

Subsequently, when having detected, according to the navigation information acquired by the navigation information acquisition unit 210, that a lane change is required for making the right turn, the vibration timing determination unit 220 determines a timing at which a lane change is required for making the right turn as a vibration timing based on the distance to the location where the right turn is to be performed and the speed of the vehicle M. In addition, the vibration parameter setting unit 230 sets a vibration parameter for notifying that a lane change is required for making the right turn. In this process, the vibration parameter setting unit 230 sets the vibration parameter so that vibration for notifying that a lane change is required for making the right turn is different from vibration for notifying that the next action is the right turn in the intensity, the frequency, and the pattern of vibration. Moreover, the vibration parameter setting unit 230 may change the intensity, the frequency, and the pattern of vibration as the vehicle approaches the location where the right turn is to be performed.

Then at time point T2, which is the vibration timing for notifying that a lane change is required for making the right turn, the reproduction signal generation unit 240 generates a reproduction signal for generating vibration in the steering wheel SW according to the vibration parameter for notifying that a lane change is required for making the right turn, and supplies the reproduction signal to the vibration devices VD1 and VD2. With this configuration, it is possible to generate vibration in the steering wheel SW to notify that a lane change is required for making the right turn, thereby prompting the driver to perform an operation to make a lane change for making the right turn.

Subsequently, when having detected, according to the navigation information acquired by the navigation information acquisition unit 210, that the vehicle has reached a location immediately before the location where the right turn is to be performed, the vibration timing determination unit 220 determines that it is the vibration timing for notifying execution of the right turn. In addition, the vibration parameter setting unit 230 sets a vibration parameter for notifying execution of the right turn. In this process, the vibration parameter setting unit 230 may set the vibration parameter so that the intensity of vibration increases according to the distance to the location where the right turn is to be performed, thereby clearly conveying the next action to the driver.

Then at time point T3, which is the vibration timing for notifying execution of the right turn, the reproduction signal generation unit 240 generates a reproduction signal for generating vibration in the steering wheel SW according to the vibration parameter for notifying execution of the right turn, and supplies the reproduction signal to the vibration devices VD1 and VD2. With this configuration, it is possible to generate vibration in the steering wheel SW to notify execution of the right turn, thereby prompting the driver to perform an operation to make the right turn.

Thereafter, after a predetermined time has elapsed or after completion of the right turn is sensed, the reproduction signal generation unit 240 stops the reproduction signal supply to the vibration devices VD1 and VD2. In this process, the next action may be detected according to the navigation information acquired by the navigation information acquisition unit 210, and vibration may be generated in the steering wheel SW according to the action.

As described above, the vibration control system 200 can generate vibration in the steering wheel Sw in coordination with the navigation system, thereby conveying the next action to the driver without relying on vision or sound, for example. In addition, the vibration control system 200 can change the intensity, the frequency, and the pattern of vibration based on the content of the next action and the distance to the location where the next action is to be performed, thereby intuitively conveying an instruction for the next right turn, left turn, or straight traveling, for example. Moreover, the vibration control system 200 can improve, for example, safety and convenience of the vehicle M by providing vibration according to a lane change or the next action.

### Exemplary Processing of Vibration Control Processing

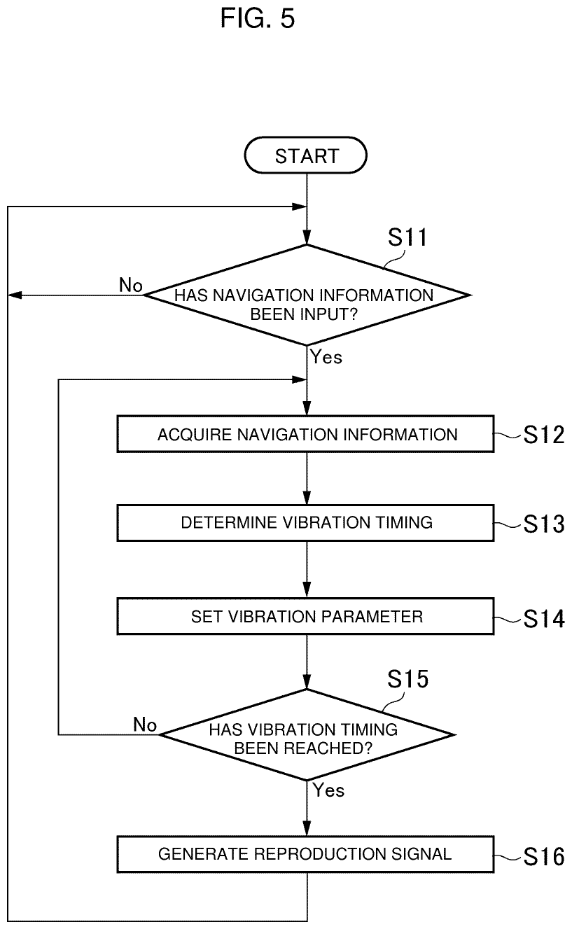

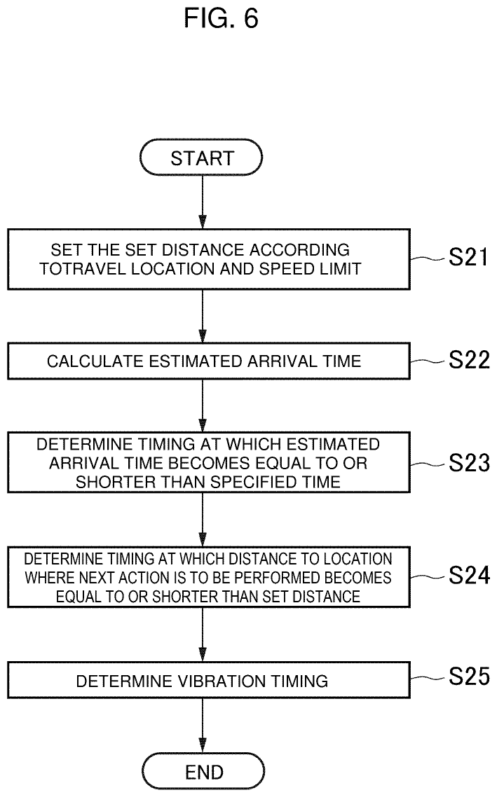

The vibration control processing executed by the vibration control system 200 will be described below by referring to flowcharts illustrated in FIGS. 5 and 6.

FIG. 5 is a flowchart for description of the vibration control processing.

For example, when power is input to the vehicle M and the processing circuit 110 is activated, the processing is started. At step S11, the navigation information acquisition unit 210 determines whether navigation information has been input from the non-illustrated navigation system to the processing circuit 110 through the input-output I/F 120, and waits for processing until it is determined that the navigation information has been input.

At step S11, if the navigation information acquisition unit 210 determines that the navigation information has been input, the processing proceeds to step S12. Then, the navigation information acquisition unit 210 acquires the navigation information input to the processing circuit 110, supplies the next-action information and the driving environment information to the vibration timing determination unit 220, and supplies the next-action information to the vibration parameter setting unit 230.

At step S13, the vibration timing determination unit 220 determines a vibration timing for generating vibration in the steering wheel SW based on the next-action information and the driving environment information supplied from the navigation information acquisition unit 210 at step S12 and speed information indicating the speed of the vehicle M detected by the vehicle speed sensor of the vehicle sensor group 40. Then, the vibration timing determination unit 220 supplies vibration timing information indicating the vibration timing to the reproduction signal generation unit 240.

At step S14, the vibration parameter setting unit 230 sets a vibration parameter for generating vibration in the steering wheel SW based on the next-action information supplied from the navigation information acquisition unit 210 at step S12 and steering angle information indicating the angle of the steering wheel SW detected by the steering sensor group 30. Then, the vibration parameter setting unit 230 supplies vibration parameter information indicating the vibration parameter to the reproduction signal generation unit 240.

At step S15, the reproduction signal generation unit 240 determines whether the vibration timing indicated by the vibration timing information supplied from the vibration timing determination unit 220 at step S13 has been reached.

At step S15, if the reproduction signal generation unit 240 determines that the vibration timing has not been reached, the processing returns to step S12. Then, the same processing is repeatedly performed based on the navigation information continuously input to the processing circuit 110 until the next action is performed (in other words, the navigation information in which the distance to the location where the next action is to be performed sequentially decreases as the vehicle M travels).

At step S15, if the reproduction signal generation unit 240 determines that the vibration timing has been reached, the processing proceeds to step S16. Then, the reproduction signal generation unit 240 generates a reproduction signal for generating vibration in the steering wheel SW according to the vibration parameter indicated by the vibration parameter information supplied from the vibration parameter setting unit 230 at step S14. Thereafter, the reproduction signal generation unit 240 outputs the reproduction signal to the amplifiers Amp1 and Amp2 through the input-output I/F 120, and then the processing returns to step S11 to repeatedly perform the same processing.

FIG. 6 is a flowchart for description of an example of the processing that the vibration timing determination unit 220 determines a vibration timing at step S13 in FIG. 5.

At step S21, the vibration timing determination unit 220 sets a set distance according to the travel location and the speed limit in the navigation information supplied from the navigation information acquisition unit 210.

For example, the vibration timing determination unit 220 can determine whether the travel location is a highway, an urban area, or a suburban area, and can set a set distance determined in advance according to the speed limit for each travel location (at or below a first speed limit, a range that is at or below the first speed limit and at or above a second speed limit, or at or below the second speed limit). Specifically, it is determined in advance to set the set distance to 230 m in a case where the travel location is a highway and the speed limit is at or below the first speed limit (for example, 100 km/h).

At step S22, the vibration timing determination unit 220 calculates an estimated arrival time estimated as a remaining time until the vehicle reaches the location where the next action is to be performed based on the distance to the location where the next action is to be performed and the speed of the vehicle M indicated by the speed information.

At step S23, the vibration timing determination unit 220 determines a timing at which the estimated arrival time calculated at step S22 becomes equal to or shorter than the specified time.

At step S24, the vibration timing determination unit 220 determines a timing at which the distance to the location where the next action is to be performed becomes equal to or shorter than the set distance set at step S21.

At step S25, the vibration timing determination unit 220 determines, as a vibration timing, the earlier one of the timing determined at step S23 and the timing determined at step S24. Accordingly, the processing of determining a vibration timing (step S13 in FIG. 5) ends, and the processing proceeds to step S14.

Through execution of the vibration control processing as described above by the vibration control system 200, it is possible to generate vibration in the steering wheel SW in coordination with the navigation system, thereby achieving navigation suited to the driving situation of the vehicle M.

The above-described series of processing (vibration control program) may be executed by hardware or software. In a case where the series of processing is executed by software, programs included in the software are installed on a computer. Examples of the computer include a computer that is incorporated in dedicated hardware and a general-purpose personal computer that is capable of executing various functions with various programs installed thereon.

The programs executed by the computer may be programs that are processed in a temporally sequential manner along an order described in the present specification, or may be programs that are processed in parallel or at necessary timings, for example, when called.

The processing performed by the computer according to the programs does not necessarily need to be performed in a temporally sequential manner along an order written in the flowcharts. Specifically, the processing performed by the computer according to the program includes processing executed in parallel or individually (for example, parallel processing or processing by objects).

The programs may be processed by one computer (processor) or in a distributed manner by a plurality of computers. Moreover, the programs may be forwarded to and executed by a remote computer.

In the present specification, a system means a set of a plurality of constituent components (such as devices and modules (components) ) irrespective of whether all constituent components are located in the same housing. Thus, a plurality of devices housed in separate housings and connected through a network, and one device with a plurality of modules housed in one housing are each a system.

For example, a component described above as one device (or processing unit) may be divided and configured as a plurality of devices (or processing units). In contrast, components described above as a plurality of devices (or processing units) may be collectively configured as one device (or processing unit). Components other than those described above may be added to the configuration of each device (or processing unit). Moreover, part of the configuration of a device (or processing unit) may be included in the configuration of another device (or processing unit) as long as the configuration and operation of the entire system remain the same in effect.

The present technology may adopt, for example, a cloud computing configuration in which one function is distributed and collaboratively processed by a plurality of devices through a network.

For example, the above-described programs may be executed at an optional device. In this case, the device may be configured to be able to have necessary functions (such as functional blocks) and obtain necessary information.

For example, each step in the above-described flowcharts may be executed at one device or at a plurality of devices in a distributed manner. In a case where a plurality of processes are included in one step, the plurality of processes included in the one step may be executed at one device or at a plurality of devices in a distributed manner. In other words, a plurality of processes included in one step may be executed as processing at a plurality of steps. In contrast, processing described above as a plurality of steps may be collectively executed as one step.

Note that processes at steps that describe a program executed by the computer may executed in a temporally sequential manner along an order described in the present specification or may be executed in parallel or individually at necessary timings, for example, when called. In other words, the processes at steps may be executed in an order different from the above-described order as long as no inconsistency occurs. Moreover, processes at steps that describe the program may be executed in parallel or combination with processes of another program.

Note that the plurality of present technologies described above in the present specification may be each independently implemented as long as no inconsistency occurs. Moreover, a plurality of optional present technologies in the present specification may be implemented in combination. For example, some or all present technologies described above in either embodiment may be implemented in combination with some or all present technologies described above in another embodiment. Furthermore, some or all optional present technologies described above may be implemented in combination with other technologies that are not described above.

Note that the present embodiment is not limited to the above-described embodiment but may be changed in various kinds of manners without departing from the scope of the present disclosure. Effects described in the present specification are merely exemplary and not limiting, and may include other effects.

### REFERENCE SIGNS LIST

10 operation support ECU; 20 steering device; 30 steering sensor group; 40 vehicle sensor group; 100 control device; 110 processing circuit; 120 input-output I/F; 130 storage unit; 200 vibration control system; 210 navigation information acquisition unit; 220 vibration timing determination unit; 230 vibration parameter setting unit; 240 reproduction signal generation unit

1. An in-vehicle system comprising:
a navigation information acquisition unit configured to acquire navigation information, the navigation information including information related to a next action of a vehicle and information related to a driving environment of the vehicle;
a vibration timing determination unit configured to determine, based on the navigation information, a vibration timing that is a timing for generating vibration to notify the next action of the vehicle; and
a vibration parameter setting unit configured to set, based on the navigation information, a vibration parameter for controlling the vibration,
wherein the vibration parameter setting unit is further configured to
set an intensity, a frequency, or a pattern of the vibration as the vibration parameter,
set the vibration parameter based on a content of the next action and a distance to a location where the vehicle is to perform the next action, and
set a first intensity, frequency, or pattern as the vibration parameter based on the vehicle being at a first distance to a location where the vehicle is to perform the next action and change the first intensity, frequency, or pattern to a second intensity, frequency, or pattern based on the vehicle being at a second distance closer to the location than the first distance, the first intensity, frequency, or pattern being different than the second intensity, frequency, or pattern, and
wherein the navigation information acquisition unit, the vibration timing determination unit, and the vibration parameter setting unit are each implemented via at least one processor.

2. The in-vehicle system according to claim 1, further comprising a signal generation unit configured to generate a signal for generating vibration according to the vibration parameter at the vibration timing, the vibration timing being determined by the vibration timing determination unit, the vibration parameter being set by the vibration parameter setting unit,
wherein the signal generation unit is implemented via at least one processor.

3. The in-vehicle system according to claim 1, wherein the vibration timing determination unit is further configured to determine the vibration timing based on a distance to a location where the vehicle is to perform the next action, a surrounding environment where the vehicle is traveling, and a speed of the vehicle.

4. The in-vehicle system according to claim 3, wherein the vibration timing determination unit is further configured to
calculate, based on the distance to the location where the vehicle is to perform the next action and the speed of the vehicle, an estimated arrival time estimated as a remaining time until the vehicle reaches the location where the vehicle is to perform the next action,
determine a first timing at which the estimated arrival time becomes equal to or shorter than a specified time that is a time between an estimated timing at which the vehicle reaches the location where the vehicle is to perform the next action and a predetermined timing earlier than the timing and is set as a time indicating a timing for starting the vibration,
determine a second timing at which the distance to the location where the vehicle is to perform the next action becomes equal to or shorter than a set distance that is a distance between the location where the next action is to be performed and a predetermined location earlier than the location and is set as a distance for starting the vibration, and
determine an earlier one of the first timing and the second timing as the vibration timing.

5. The in-vehicle system according to claim 4, wherein the set distance is set in advance according to a travel location that is the surrounding environment where the vehicle is traveling and a speed limit.

6. (canceled)

7. (canceled)

8. The in-vehicle system according to claim 1, wherein in a case where a lane change is required for the vehicle to perform the next action, the vibration parameter setting unit is further configured to set the vibration parameter for notifying that a lane change is required at a timing of a predetermined distance from the location where the next action is to be performed.

9. The in-vehicle system according to claim 1, wherein the vibration parameter setting unit is further configured to change the vibration parameter so that vibration is more clearly conveyed as the vehicle approaches the location where the next action is to be performed.

10. The in-vehicle system according to claim 1, wherein the vibration parameter setting unit is further configured to set the vibration parameter for notifying execution of the next action at a timing when the vehicle reaches a location immediately before the location where the next action is to be performed.

11. The in-vehicle system according to claim 1, wherein when the vibration is generated in a steering wheel of the vehicle and a plurality of vibration devices are mounted on the steering wheel, the vibration parameter setting unit is further configured to set the vibration parameter adapted to a disposition position of each of the plurality of vibration devices based on a steering angle of the steering wheel.

12. A non-transitory computer-readable medium having embodied thereon a program, which when executed by a computer causes the computer to execute a processing method, the method comprising:
acquiring navigation information, the navigation information including information related to a next action of a vehicle and information related to a driving environment of the vehicle;
determining a vibration timing based on the navigation information, the vibration timing being a timing for generating vibration to notify the next action of the vehicle; and
setting a vibration parameter for controlling the vibration based on the navigation information,
wherein the setting of the vibration parameter further includes
setting an intensity, a frequency, or a pattern of the vibration as the vibration parameter,
setting the vibration parameter based on a content of the next action and a distance to a location where the vehicle is to perform the next action, and
setting a first intensity, frequency, or pattern as the vibration parameter based on the vehicle being at a first distance to a location where the vehicle is to perform the next action and changing the first intensity, frequency, or pattern to a second intensity, frequency, or pattern based on the vehicle being at a second distance closer to the location than the first distance, the first intensity, frequency, or pattern being different than the second intensity, frequency, or pattern.

13. A processing method, the method comprising:
acquiring navigation information, the navigation information including information related to a next action of a vehicle and information related to a driving environment of the vehicle;
determining a vibration timing based on the navigation information, the vibration timing being a timing for generating vibration to notify the next action of the vehicle; and
setting a vibration parameter for controlling the vibration based on the navigation information,
wherein the setting of the vibration parameter further includes
setting an intensity, a frequency, or a pattern of the vibration as the vibration parameter,
setting the vibration parameter based on a content of the next action and a distance to a location where the vehicle is to perform the next action, and
setting a first intensity, frequency, or pattern as the vibration parameter based on the vehicle being at a first distance to a location where the vehicle is to perform the next action and changing the first intensity, frequency, or pattern to a second intensity, frequency, or pattern based on the vehicle being at a second distance closer to the location than the first distance, the first intensity, frequency, or pattern being different than the second intensity, frequency, or pattern.
